(19) United States
(12) Patent Application Publication
(10) Pub. No.: US 2026/0142713 A1
(43) Pub. Date: May 21, 2026

(54) ENHANCED RADIO ACCESS NETWORK BEAM SIGNALING AND BEAM FAILURE RECOVERY FOR MULTIPLE TRANSMIT/RECEIVE POINT WIRELESS OPERATIONS

(71) Applicant: INTEL CORPORATION, Santa Clara, CA (US)

(72) Inventors: Avik SENGUPTA, San Jose, CA (US); Bishwarup MONDAL, San Ramon, CA (US)

(73) Assignee: INTEL CORPORATION, Santa Clara, CA (US)

(21) Appl. No.: 19/119,737

(22) PCT Filed: Oct. 30, 2023
(86) PCT No.: PCT/US2023/078179

§ 371 Date: Apr. 9, 2025

Related U.S. Application Data
(60) Provisional application No. 63/422,969, filed on Nov. 5, 2022.
(60) Provisional application No. 63/424,671, filed on Nov. 11, 2022.
(60) Provisional application No. 63/485,226, filed on Feb. 15, 2023.
(60) Provisional application No. 63/494,963, filed on Apr. 7, 2023.

(51) Int. Cl. H04B 7/06; H04W 72/1268; H04W 72/231

(52) U.S. Cl. CPC H04B 7/06964; H04B 7/06968; H04W 72/1268; H04W 72/231

(57) ABSTRACT

This disclosure describes systems, methods, and devices for beam signaling, beam failure recovery (BFR), a transmission configuration indicator (TCI), and multiple transmit/receive point (multi-TRP) operations. A device may set a first coresetpoolindex value for at least one physical uplink control channel (PUCCH) resource; identify a match between the first coresetpoolindex value and a second coresetpoolindex value of a beam indication in downlink control information received by the UE device; and based on the match, update a transmission configuration indicator (TCI) for the at least one PUCCH resource.

### CROSS-REFERENCE TO RELATED PATENT APPLICATIONS

This application claims the benefit of U.S. Provisional Application No. 63/422,969, filed Nov. 5, 2022, U.S. Provisional Application No. 63/424,671, filed Nov. 11, 2022, U.S. Provisional Application No. 63/485,226, filed Feb. 15, 2023, and U.S. Provisional Application No. 63/494,963, filed Apr. 7, 2023, the disclosures of which are incorporated herein by reference as if set forth in full.

### TECHNICAL FIELD

This disclosure generally relates to systems and methods for wireless communications and, more particularly, to a radio access network beam indication and beam failure recovery with a unified transmission configuration indicator for multiple transmit/receive point operations.

### BACKGROUND

Wireless devices are becoming widely prevalent and are increasingly using wireless channels. The 3^{rd} Generation Partnership Program (3GPP) is developing one or more standards for wireless communications.

### BRIEF DESCRIPTION OF THE DRAWINGS

FIG. 1 is a network diagram illustrating an example network environment, in accordance with one or more example embodiments of the present disclosure.

FIG. 2 illustrates an example coresetpoolindex-based transmission configuration indicator (TCI) state application for multi-downlink control information (multi-DCI)-based multiple transmit/receive point (multi-TRP) operations, in accordance with one or more example embodiments of the present disclosure.

FIG. 3 illustrates an example beam application time for multi-DCI multi-TRP with joint hybrid automatic repeat request-acknowledgement (HARQ-ACK) feedback, in accordance with one or more example embodiments of the present disclosure.

FIG. 4 illustrates example dynamic switching between single TRP and multi-TRP schemes, in accordance with one or more example embodiments of the present disclosure.

FIG. 5 illustrates example dynamic switching of single TRP and multi-TRP schemes using a number of indicated TCI states and a DCI indicator field, in accordance with one or more example embodiments of the present disclosure.

FIG. 6 illustrates a flow diagram of illustrative process for beam signaling, beam failure recovery (BFR), a transmission configuration indicator (TCI), and multiple transmit/receive point (multi-TRP) operations, in accordance with one or more example embodiments of the present disclosure.

FIG. 7. illustrates a network, in accordance with one or more example embodiments of the present disclosure.

FIG. 8 schematically illustrates a wireless network, in accordance with one or more example embodiments of the present disclosure.

FIG. 9 is a block diagram illustrating components, in accordance with one or more example embodiments of the present disclosure.

FIG. 10 illustrates a network, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wireless devices may operate as defined by technical standards. For cellular telecommunications, the 3^{rd} Generation Partnership Program (3GPP) define communication techniques, including for beam signaling, beam failure recovery (BFR), a transmission configuration indicator (TCI), and multiple transmit/receive point (multi-TRP) operations.

In 3GPP, a transmit/receive point for multi-TRP operations may refer to part of a gNB transmitting to and receiving radio signals from a UE according to physical layer (PHY) properties and parameters of the element. In Multiple Transmit/Receive Point (multi-TRP) operation, a serving cell can schedule UE from two TRPs, providing better PDSCH coverage, reliability and/or data rates.

Also in 3GPP, a beam failure (e.g., distinguished from radio link failure because radio link failure may not allow for UE recovery) may refer to an interruption of a communication link, such as when a radio link between a UE and a gNB is blocked and/or the signal degrades. To detect the beam failure, the UE may use a BFR procedure with PHY and MAC layers without requiring use of higher communication layer signaling. BRF may allow a UE to lose a link from one beam, but establish another link to another beam by switching beam pairs used for communication.

3GPP communications use TCI signaling for beam management. For example, TCI signaling may indicate a beam for a target channel/signal. The UE can set its beamforming coefficients based on the TCI signaling.

3GPP Release 17 (Rel-17) defined a unified TCI framework. Release 18 (Rel-18) of 3GPP may enhance MIMO beam management by extending the Rel-17 unified TCI framework to signal multiple DL and UL TCI states focusing on a multi-TRP use case. In Rel-17 NR (new radio), a new unified TCI framework was specified for common beam operation in both DL and UL through the mean for joint DL/UL TCI states when the same beam is used in the DL/UL with full beam correspondence and with separate DL and UL TCI (e.g., replacing the uplink spatial relation information framework) for the case of no beam correspondence where a separate DL and UL beam are used. However, the Rel-17 unified TCI framework was supported for only single TRP operations.

The present disclosure provides a system and method beam indication and beam failure recovery for multi-TRP operations, which leverages the unified TCI framework. The present disclosure provides new schemes for PUCCH beam indication for transmission to different TRPs in multi-DCI operations, and new schemes for beam indication and beam failure detection for single-DCI based multi-TRP operations.

### Multi-DIC-Based Multi TRP:

In one or more embodiments, for a PUCCH transmission of multi-DCI based multi-TRP, a PUCCH resource or resource group can be configured by RRC to be associated to a specific value of a coresetPoolIndex (e.g., a configuration parameter signaling at least one coreset (control resource set), which includes physical resources on which a PDCCH/DCI transmission may be transmitted), such that when a DCI based beam indication updates a joint/UL TCI state for a specific coresetPoolIndex value, the PUCCH resource/sets associated to the coresetPoolIndex value also updates its TCI state. In one embodiment, when joint HARQ-ACK feedback is enabled for multi-DCI multi-TRP, the PUCCH resource used for transmission of the HARQ-ACK filter uses the last activated joint/UL TCI state corresponding to the coresetPoolIndex value with which the PUCCH resource or resource set containing the resource is associated irrespective of the coresetPoolIndex value of the last beam indication/scheduling DCI.

In one or more embodiments, instead of a specific value of coresetPoolIndex, a new index or identity value (ID) can be introduced for which the ID has a plurality of values. In one example, the ID corresponds to values {0, 1}, while in another example, the ID can correspond to values {0, 1, 2 . . . , N} where N is configured by higher layers or based on UE capability. The PUCCH resource or resource group in this case can be configured by RRC or MAC-CE to be associated with a value of this ID.

In one or more embodiments, a TCI state can be configured to be associated with a value of the ID. The association can be configured between the TCI state and the ID value by RRC configuration. In one example, the RRC configuration can be a TCI state group which contains a set of TCI states with which a value of the ID is associated or included. Alternatively, individual TCI states can also be associated with a value of the ID. In another embodiment, the association between TCI state and the ID value can be configured by MAC-CE, where each activated TCI state ID also includes an associated ID value. In another embodiment, a bit or plurality of bits included in the beam indication DCI formats 1_1/1_2 with or without downlink scheduling assignment or an UL DCI format 0_1/0_2, indicates the value of the ID with which the indicated TCI state is associated.

In one or more embodiments, the indicated TCI state may apply only to the PUCCH resource or resource sets which are associated with the same ID with which the indicated TCI state is also associated, irrespective of the PRI (PUCCH resource indicator) value included in the beam indication DCI. In another embodiment, the indicated TCI state is only applicable to the PUCCH resource indicated by the PRI value if the PUCCH is associated with the same ID value as the indicated TCI state.

In one or more embodiments, for multi-DCI based multi-TRP, when joint HARQ-ACK feedback is configured, the beam application time (BAT) is counted from the last symbol of the PUCCH carrying the joint HARQ feedback. The beam application time corresponding to two values of the TRP index which can be either coresetPoolIndex or a configured ID as in previous embodiments can be configured to be different. In the case that the BAT is different for each of the two DCIs, corresponding TCI states indicated by each DCI becomes active only in the slot after the end of the BAT for each beam indication DCI.

In one or more embodiments, for single DCI based multi-TRP operation, a MAC-CE for TCI state activation can map a single TCI state to a TCI codepoint. In this case, the MAC-CE also includes an ID with a plurality of values e.g., 2 values corresponding to a TCI state group which maps to a specific TRP or directly corresponding to a TRP. When a TCI codepoint mapped to single TCI state and including a value for this ID is indicated by a DCI for beam indication, the applies the indicated TCI state to the TRP which corresponds configured ID. In one example, the ID value is included if only one TCI state is mapped to a codepoint. If the codepoint is mapped to two joint/DL/UL or two pairs of DL+UL TCI states, the UE assumes the first mapped TCI state maps to the first ID value and the second mapped TCI state corresponds to the second ID value. In another example, when two TCI states are mapped to a codepoint, the activation MAC-CE includes two values for the ID which indicate which TRPs the activated TCI states are applicable to. In one embodiment, the ID could be analogous to coresetPoolIndex. In another embodiment, the ID can correspond to a TCI state group or SSB group where the grouping of TCI states and/or SSBs is configured by RRC, and each group corresponds to a different TRP. When a MAC-CE codepoint is mapped to two DL/UL/joint or two pairs of DL+UL TCI states, the two (pairs) of TCI states may be from different TCI state or SSB groups.

In legacy Rel-16 NR, the switching between single DCI multi-TRP schemes and sTRP schemes can be dynamically performed based on the number of TCI states mapped to the TCI codepoint indicated by a DCI and the number of DM-RS CDM groups in the Antenna port indication field in the DCI.

For Rel-18 NR with single DCI multi-TRP operation with unified TCI framework, a new indicator field may be introduced in the DCI formats 1_1/1_2 scheduling PDSCH(s), which will indicate whether a UE should apply the first or second indicated DL/joint TCI state or both indicated DL/joint TCI state to the scheduled PDSCH(s).

In one or more embodiments, the DCI indicator field, when configured to be present by RRC, may be used in conjunction with the number of TCI states mapped to the indicated TCI state codepoint and the number of indicated DM-RS CDM groups to determine dynamic switching between single and multi-TRP schemes i.e., for the case when the TDRA (time domain resource assignment) indicates supportRepNumPDSCH-TDRA-r16 is not present and when an indicated TCI codepoint is mapped to only single DL/joint TCI state, the UE assumes sTRP operation. Otherwise, if the indicated TCI codepoint is mapped to more than one DL/joint TCI states, the indicator field in the DCI is used to determine single TRP vs multi-TRP operation i.e., if the indicator field indicates application of only a single DL/joint TCI state using values ‘00’/‘01’ corresponding to the 1st DL/joint TCI state mapped to the TCI codepoint or the 2nd DL/joint TCI state mapped to the TCI codepoint respectively, the UE assumes sTRP operation. If the DCI indicator field indicates application of two indicated DL/joint TCI states using values ‘10’/11’, then dynamic switching between scheme 1a (NC-JT) or 2a (FDMScheme-A)/2b (FDMScheme-B)/3 (TDMSchemeA-intra-slot repetition).

Additionally for the case when supportRepNumPDSCH-TDRA-r16>1 indicated by DCI TDRA, when an indicated TCI codepoint is mapped to only single DL/joint TCI state, the UE assumes sTRP operation. If the indicated TCI codepoint is mapped to more than one DL/joint TCI states, the indicator field in the DCI is used to determine single TRP vs multi-TRP operation i.e., if the indicator field indicates application of only a single DL/joint TCI state using values ‘00’/‘01’ corresponding to the 1st DL/joint TCI state mapped to the TCI codepoint or the 2nd DL/joint TCI state mapped to the TCI codepoint respectively, the UE assumes sTRP operation. If the DCI indicator field indicates application of two indicated DL/joint TCI states using values ‘10’/11’, then UE assumes a mTRP operation (e.g., TDMScheme-B-inter slot repetition).

In one or more embodiments, when the DCI indicator field is configured to be present, only the values of the DCI indicator field are used to switch between single and multi-TRP schemes. In this case, if the number of DL/joint TCI states mapped to the TCI codepoint indicated by DCI is more than 1, then the same operation as in Error! Reference source not found. is assumed. However, if a single DL/joint TCI state is mapped to the TCI codepoint indicated by DCI, then the DCI indicator field can be reinterpreted by the UE to switch between sTRP and mTRP operation. As an example, when single DL/joint TCI state is indicated the value “00” of the DCI indicator field can indicate that the single indicated TCI state is the 1st indicated TCI state corresponding to TRP-1 and only the first indicated TCI state should be updated while keeping the other TCI state the same and this signals mTRP operation with update of only one TCI state. Similarly, the value “01” of the DCI indicator field can indicate that the single indicated TCI state is the 2nd indicated TCI state corresponding to TRP-2 and only the second indicated TCI state should be updated while keeping the other TCI state the same and this signals mTRP operation with update of only one TCI state. The value “10” or “11” can be interpreted to be sTRP operation in this case.

In one or more embodiments, when the DCI indicator field is configured by RRC to be present, and the DCI schedules or activates a PDSCH reception such that the scheduling offset is below a threshold which is required for the UE to decode the DCI and interpret the DCI indicator field, if the UE reports a capability of not supporting two default beams in FR2, the UE does not expect the PDSCH to be scheduled in mTRP mode i.e., below the threshold only sTRP scheduling is possible for such a UE.

In one or more embodiments, if the DCI indicator field is configured by RRC to be not present, then the legacy dynamic switching between sTRP and mTRP operation is followed where the switching occurs based on the number of indicated TCI states and number of CDM groups i.e., if the field is not configured and the UE is indicated with a TCI codepoint mapped to more than one DL/joint TCI states, the UE assumes mTRP operation and applies both TCI states. In another embodiment, if the DCI indicator field is RRC configured to be not present, dynamic switching between sTRP operation and mTRP operation is not supported. In one example, the sTRP/mTRP switching is done on the basis of the MAC-CE activated TCI state mapping. If the MAC-CE activates any of the 8 TCI codepoints with more than one joint/DL/UL TCI state, the UE can assume mTRP operation and only if all codepoints are mapped to single joint/DL/UL or one DL+one UL TCI state, the UE can assume sTRP operation. In another embodiment, when RRC configures the DCI indicator field to be not present in the DCI. UE expects RRC to also configure sTRP or mTRP operation mode i.e., semi-static switching between sTRP and mTRP modes is expected.

In one or more embodiments, when the DCI indicator field is configured by RRC to be not present, and the DCI schedules or activates a PDSCH reception such that the scheduling offset is below a threshold which is required for the UE to decode the DCI and interpret the DCI indicator field, if the UE reports a capability of supporting two default beams in FR2, the UE is expected to apply both the beams to buffer the data. In one example, the default beams are the indicated DL/UL/joint TCI states which are active at the time when the PDSCH reception begins. In one embodiment, the UE is not expected to change beams until after the end of the PDSCH reception if the PDSCH reception begins before a threshold and the last symbol of the scheduled PDSCH occurs after the threshold. In another embodiment, the UE changes to the two beams indicated by the scheduling DCI at the first slot boundary which occurs after the threshold. In one embodiment, if the UE does not report a capability of supporting two default beams, the UE does not expect to be scheduled with a S-DCI mTRP PDSCH/PUSCH starting before a threshold from the last symbol of the scheduling DCI.

For beam failure recovery purposes, a set of beam failure detection RSs may be implicitly determined by the UE based on activated and or indicated joint/DL TCI states. In one embodiment, for activated TCI codepoints mapped to two TCI states, the UE may assume that the set of TCIs which are mapped as the first TCI state in a codepoint are part of a 1st BFD-RS (BFD resource set) set and the set of TCI states mapped as the second TCI states in codepoint are part of a second BFD-RS set. Each BFD-RS set can correspond to a different TRP. In another embodiment, the value of the ID associated with the TCI state mapped to a codepoint can have one-to-one correspondence with the BFD-RS set ID i.e., the ID or IDs configured to the activated TCI codepoints by MAC-CE indicates which BFD-RS sets these TCI states belong to. In another embodiment, there can be a one-to-one correspondence between BFD-RS sets and coresetPoolIndex for single-DCI multi-TRP. In one embodiment, if the number of BFD-RSs determined implicitly exceeds the number of BFD-RSs that can be supported by the UE per BFD-RS set, the UE can assume that only the first N unique TCI states in the BFD-RS set are valid where N is the maximum number of BFD-RSs per BFD-RS set that can be supported by the UE.

In one or more embodiments, for single DCI based PUCCH transmission, a PUCCH resource or resource group can be configured by RRC to be associated with one of the IDs configured by the TCI activation MAC-CE. Depending on the associated ID, the PUCCH resource follows corresponding TCI state when a codepoint is indicated. In one embodiment, if a TCI codepoint is indicated by DCI which updates the TCI state (joint/DL/UL) for only one TRP or corresponds to only one ID, the PUCCH resource or resource groups which are RRC configured to be associated with the other TRP or other ID or with a TCI state group that is not updated, the respective PUCCH resource continues to follow the last activated TCI state.

### Beam Failure Recovery Response:

In one or more embodiments, for single-DCI multi-TRP, the beam failure recovery MAC-CE also indicates the ID value of the failed TRP and the new beam if found also corresponds to the same ID value. In one example, this ID value may be replaced by a TCI state group. The UE is expected to apply the new TCI indicated by the BFR response PDCCH to all the signals/channels which shared the TCI state to the corresponding TRP.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

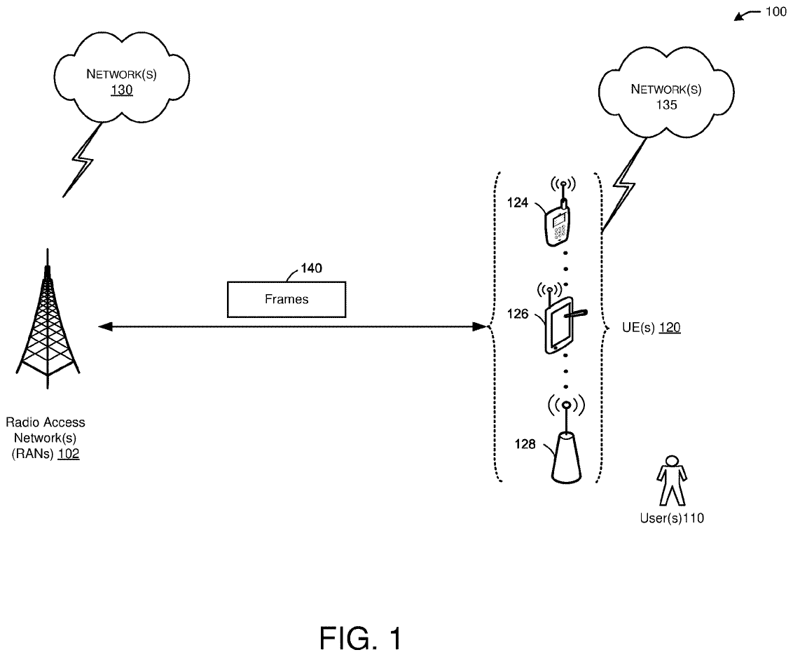

FIG. 1 is a network diagram illustrating an example network environment 100, in accordance with one or more example embodiments of the present disclosure.

Wireless network 100 may include one or more UEs 120 and one or more RANs 102 (e.g., gNBs), which may communicate in accordance with 3GPP communication standards. The UE(s) 120 may be mobile devices that are non-stationary (e.g., not having fixed locations) or may be stationary devices.

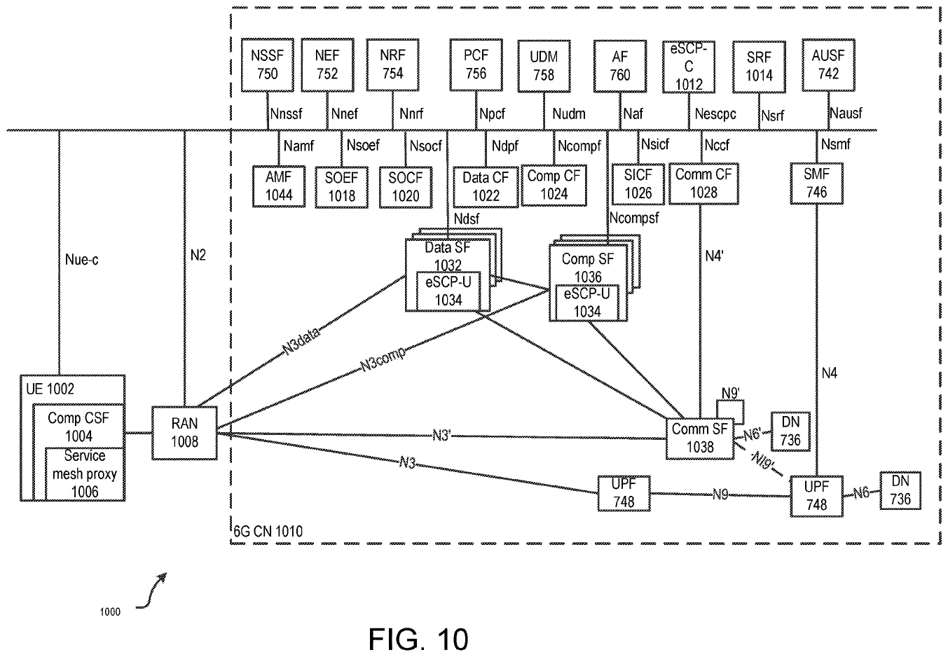

In some embodiments, the UEs 120 and the RANs 102 may include one or more computer systems similar to that of FIGS. 10-12.

One or more illustrative UE(s) 120 and/or RAN(s) 102 may be operable by one or more user(s) 110. A UE may take on multiple distinct characteristics, each of which shape its function. For example, a single addressable unit might simultaneously be a portable UE, a quality-of-service (QoS) UE, a dependent UE, and a hidden UE. The UE(s) 120 (e.g., 124, 126, or 128) and/or RAN(s) 102 may include any suitable processor-driven device including, but not limited to, a mobile device or a non-mobile, e.g., a static device. For example, UE(s) 120 may include, a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

Any of the UE(s) 120 (e.g., UEs 124, 126, 128), and UE(s) 120 may be configured to communicate with each other via one or more communications networks 130 and/or 135 wirelessly or wired. The UE(s) 120 may also communicate peer-to-peer or directly with each other with or without the RAN(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, cellular networks. In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the UE(s) 120 (e.g., UE 124, 126, 128) and RAN(s) 102 may include one or more communications antennas. The one or more communications antennas may be any suitable type of antennas corresponding to the communications protocols used by the UE(s) 120 (e.g., UEs 124, 126 and 128), and RAN(s) 102. Some non-limiting examples of suitable communications antennas include cellular antennas, 3GPP family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the UEs 120 and/or RAN(s) 102.

Any of the UE(s) 120 (e.g., UE 124, 126, 128), and RAN(s) 102 may be configured to perform directional transmission and/or directional reception in conjunction with wirelessly communicating in a wireless network. Any of the UE(s) 120 (e.g., UE 124, 126, 128), and RAN(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the UE(s) 120 (e.g., UE 124, 126, 128), and RAN(s) 102 may be configured to perform any given directional transmission towards one or more defined transmit sectors. Any of the UE(s) 120 (e.g., UE 124, 126, 128), and RAN(s) 102 may be configured to perform any given directional reception from one or more defined receive sectors.

MIMO beamforming in a wireless network may be accomplished using RF beamforming and/or digital beamforming. In some embodiments, in performing a given MIMO transmission, UE 120 and/or RAN(s) 102 may be configured to use all or a subset of its one or more communications antennas to perform MIMO beamforming.

Any of the UE 120 (e.g., UE 124, 126, 128), and RAN(s) 102 may include any suitable radio and/or transceiver for transmitting and/or receiving radio frequency (RF) signals in the bandwidth and/or channels corresponding to the communications protocols utilized by any of the UE(s) 120 and RAN(s) 102 to communicate with each other. The radio components may include hardware and/or software to modulate and/or demodulate communications signals according to pre-established transmission protocols. The radio components may further have hardware and/or software instructions to communicate via one or more 3GPP protocols and using 3GPP bandwidths. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one or more embodiments, and with reference to FIG. 1, one or more of the UEs 120 may exchange frames 140 with the RANs 102. The frames 140 may include UL and DL frames, including for beam indications, BFR, DCI, multi-TRP transmissions, and other transmissions as described herein.

It is understood that the above descriptions are for purposes of illustration and are not meant to be limiting.

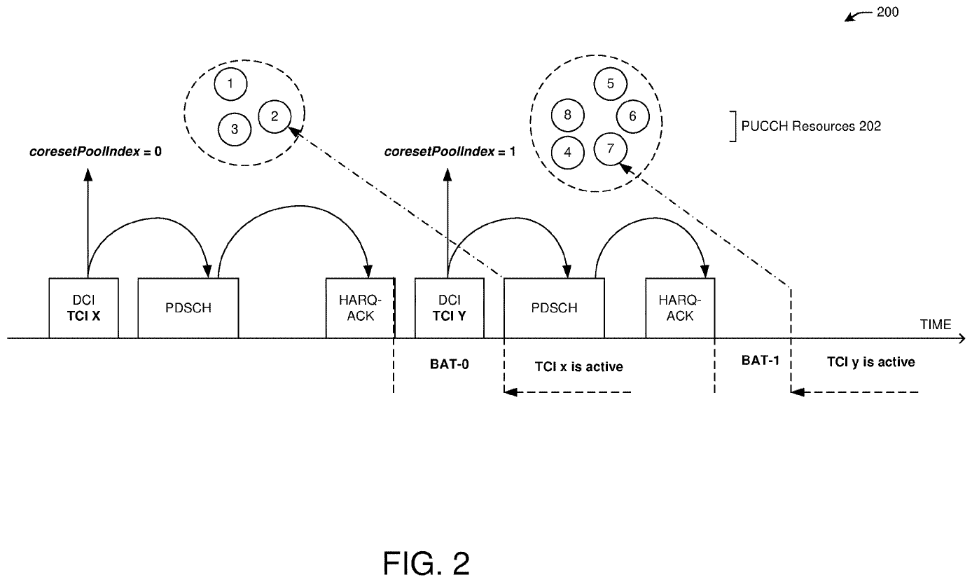

FIG. 2 illustrates an example coresetpoolindex-based transmission configuration indicator (TCI) state application 200 for multi-downlink control information (multi-DCI)-based multiple transmit/receive point (multi-TRP) operations, in accordance with one or more example embodiments of the present disclosure.

Referring to FIG. 2, for a PUCCH transmission of multi-DCI based multi-TRP, a PUCCH resource or resource group (e.g., PUCCH resources 202) can be configured by RRC to be associated with a specific value of a coresetPoolIndex (e.g., coresetPoolIndex=0, coresetPoolIndex=1), such that when a DCI-based beam indication updates a joint/UL TCI state (e.g., DCI TCI X, DCI TCI Y) for a specific coresetPoolIndex value, the PUCCH resource/sets associated with the coresetPoolIndex value also updates its TCI state. In one embodiment, when joint HARQ-ACK feedback is enabled for multi-DCI multi-TRP, the PUCCH resource used for transmission of the HARQ-ACK filter uses the last activated joint/UL TCI state corresponding to the coresetPoolIndex value with which the PUCCH resource or resource set containing the resource is associated irrespective of the coresetPoolIndex value of the last beam indication/scheduling DCI.

In another embodiment, instead of a specific value of coresetPoolIndex, a new index or identity value (ID) can be introduced where the ID has a plurality of values. In one example, the ID corresponds to values {0, 1}, while in another example, the ID can correspond to values {0, 1, 2 . . . , N} where N is configured by higher layers or based on UE capability. The PUCCH resource or resource group in this case can be configured by RRC or MAC-CE to be associated with a value of this ID.

In one embodiment, a TCI state can be configured to be associated with a value of this ID. In one embodiment, the association can be configured between the TCI state and the ID value by RRC configuration. In one example, the RRC configuration can be a TCI state group which contains a set of TCI states with which a value of the ID is associated or included. Alternatively, individual TCI states can also be associated with a value of the ID. In another embodiment, the association between TCI state and the ID value can be configured by MAC-CE, where each activated TCI state ID also includes an associated ID value. In another embodiment, a bit or plurality of bits included in the beam indication DCI formats 1_1/1_2 with or without downlink scheduling assignment or an UL DCI format 0_1/0_2, indicates the value of the ID with which the indicated TCI state is associated.

In one embodiment, the indicated TCI state applies only to the PUCCH resource or resource sets which are associated with the same ID with which the indicated TCI state is also associated, irrespective of the PRI value included in the beam indication DCI. In another embodiment, the indicated TCI state is only applicable to the PUCCH resource indicated by the PRI value if the PUCCH is associated with the same ID value as the indicated TCI state.

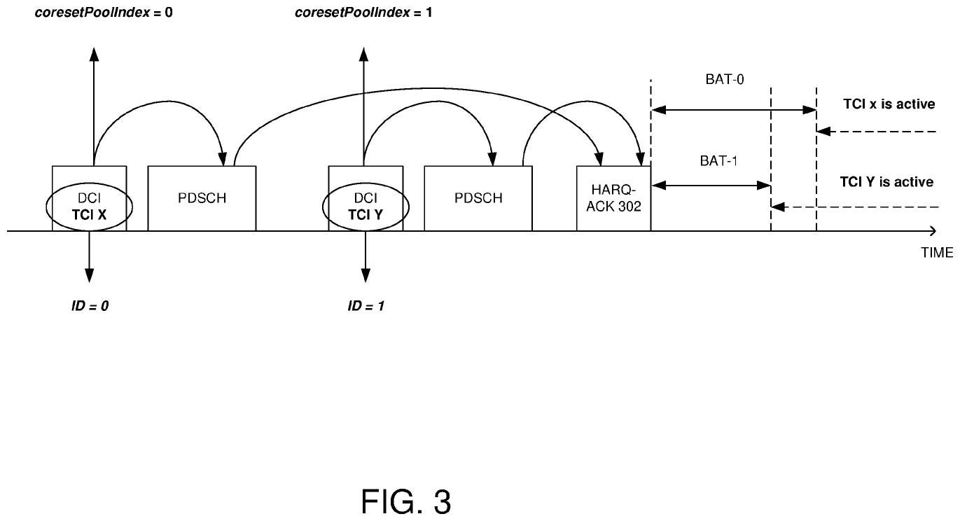

FIG. 3 illustrates an example beam application time for multi-DCI multi-TRP with joint hybrid automatic repeat request-acknowledgement (HARQ-ACK) feedback, in accordance with one or more example embodiments of the present disclosure.

Referring to FIG. 3, for multi-DCI based multi-TRP, when joint HARQ-ACK feedback 302 is configured, the beam application time (BAT—e.g., BAT-1, BAT-1) is counted from the last symbol of the PUCCH carrying the joint HARQ feedback 302. The beam application time corresponding to two values of the TRP index, which can be either coresetPoolIndex or a configured ID as in previous embodiments, can be configured to be different (e.g., BAT-0 different than BAT-1). In the case that the BAT is different for each of the two DCIs, corresponding TCI states indicated by each DCI (e.g., DCI TCI X, DCI TCI Y) become active only in the slot after the end of the BAT for each beam indication DCI.

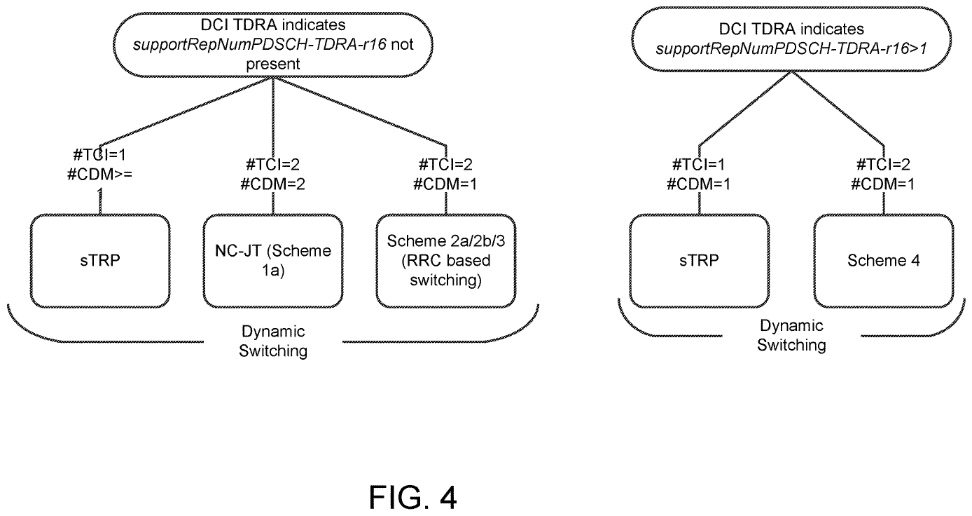

FIG. 4 illustrates example dynamic switching between single TRP and multi-TRP schemes, in accordance with one or more example embodiments of the present disclosure.

Referring to FIG. 4, for single DCI-based multi-TRP operations, a MAC-CE for TCI state activation can map a single TCI state to a TCI codepoint. In this case, the MAC-CE also includes an ID with a plurality of values (e.g., two values) corresponding to a TCI state group which maps to a specific TRP or directly corresponding to a TRP. When a TCI codepoint mapped to single TCI state and including a value for this ID is indicated by a DCI for beam indication, the indicated TCI state may be applied to the TRP which corresponds configured ID. In one example, the ID value is included if only one TCI state is mapped to a codepoint. If the codepoint is mapped to two joint/DL/UL or two pairs of DL+UL TCI states, the UE assumes the first mapped TCI state maps to the first ID value and the second mapped TCI state corresponds to the second ID value. In another example, when two TCI states are mapped to a codepoint, the activation MAC-CE includes two values for the ID which indicate which TRPs the activated TCI states are applicable to. In one embodiment, the ID could be analogous to coresetPoolIndex. In another embodiment, the ID can correspond to a TCI state group or SSB group where the grouping of TCI states and/or SSBs is configured by RRC, and each group corresponds to a different TRP. When a MAC-CE codepoint is mapped to two DL/UL/joint or two pairs of DL+UL TCI states, the two (pairs) of TCI states may be from different TCI state or SSB groups.

In legacy 3GPP Rel-16 NR, the switching between single DCI multi-TRP schemes and sTRP schemes can be dynamically performed based on the number of TCI states mapped to the TCI codepoint indicated by a DCI and the number of DM-RS CDM groups in the Antenna port indication field in the DCI. FIG. 4 illustrates the switching mechanism.

For 3GPP Rel-18 NR with single DCI multi-TRP operation with unified TCI framework, a new indicator field will be introduced in the DCI formats 1_1/1_2 scheduling PDSCH(s), which will indicate whether a UE should apply the first or second indicated DL/joint TCI state or both indicated DL/joint TCI state to the scheduled PDSCH(s).

In one embodiment, the DCI indicator field, when configured to be present by RRC, will be used in conjunction with the number of TCI states mapped to the indicated TCI state codepoint and the number of indicated DM-RS CDM groups to determine dynamic switching between single and multi-TRP schemes i.e., for the case when TDRA indicates supportRepNumPDSCH-TDRA-r16 is not present and when an indicated TCI codepoint is mapped to only single DL/joint TCI state, the UE assumes sTRP operation. Otherwise, if the indicated TCI codepoint is mapped to more than one DL/joint TCI states, the indicator field in the DCI is used to determine single TRP vs multi-TRP operation i.e., if the indicator field indicates application of only a single DL/joint TCI state using values ‘00’/‘01’ corresponding to the 1st DL/joint TCI state mapped to the TCI codepoint or the 2nd DL/joint TCI state mapped to the TCI codepoint respectively, the UE assumes sTRP operation. If the DCI indicator field indicates application of two indicated DL/joint TCI states using values ‘10’/11’, then dynamic switching between scheme 1a (NC-JT) or 2a (FDMScheme-A)/2b (FDMScheme-B)/3 (TDMSchemeA-intra-slot repetition).

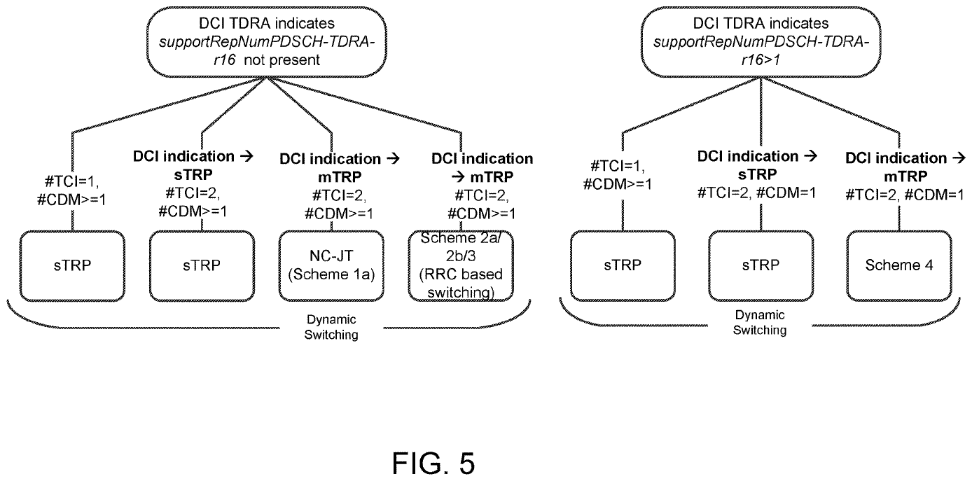

FIG. 5 illustrates example dynamic switching of single TRP and multi-TRP schemes using a number of indicated TCI states and a DCI indicator field, in accordance with one or more example embodiments of the present disclosure.

Referring to FIG. 5, for the case when supportRepNumPDSCH-TDRA-r16>1 indicated by DCI TDRA, when an indicated TCI codepoint is mapped to only single DL/joint TCI state, the UE assumes sTRP operation. If the indicated TCI codepoint is mapped to more than one DL/joint TCI states, the indicator field in the DCI is used to determine single TRP vs multi-TRP operation i.e., if the indicator field indicates application of only a single DL/joint TCI state using values ‘00’/‘01’ corresponding to the 1st DL/joint TCI state mapped to the TCI codepoint or the 2nd DL/joint TCI state mapped to the TCI codepoint respectively, the UE assumes sTRP operation. If the DCI indicator field indicates application of two indicated DL/joint TCI states using values ‘10’/11’, then UE assumes mTRP operation according to Scheme 4 (TDMScheme-B-inter slot repetition).

In another embodiment, when the DCI indicator field is configured to be present, only the values of the DCI indicator field are used to switch between single and multi-TRP schemes. In this case, if the number of DL/joint TCI states mapped to the TCI codepoint indicated by DCI is more than 1, then the same operation as in FIG. 5 may be assumed. However, if a single DL/joint TCI state is mapped to the TCI codepoint indicated by DCI, then the DCI indicator field can be reinterpreted by the UE to switch between sTRP and mTRP operation. As an example, when single DL/joint TCI state is indicated the value “00” of the DCI indicator field can indicate that the single indicated TCI state is the 1st indicated TCI state corresponding to TRP-1 and only the first indicated TCI state should be updated while keeping the other TCI state the same and this signals mTRP operation with update of only one TCI state. Similarly, the value “01” of the DCI indicator field can indicate that the single indicated TCI state is the 2nd indicated TCI state corresponding to TRP-2 and only the second indicated TCI state should be updated while keeping the other TCI state the same and this signals mTRP operation with update of only one TCI state. The value “10” or “11” can be interpreted to be sTRP operation in this case.

In another embodiment, when the DCI indicator field is configured by RRC to be present, and the DCI schedules or activates a PDSCH reception such that the scheduling offset is below a threshold which is required for the UE to decode the DCI and interpret the DCI indicator field, if the UE reports a capability of not supporting two default beams in FR2, the UE does not expect the PDSCH to be scheduled in mTRP mode i.e., below the threshold only sTRP scheduling is possible for such a UE.

In one embodiment, if the DCI indicator field is configured by RRC to be not present, then the legacy dynamic switching between sTRP and mTRP operation is followed where the switching occurs based on the number of indicated TCI states and number of CDM groups i.e., if the field is not configured and the UE is indicated with a TCI codepoint mapped to more than one DL/joint TCI states, the UE assumes mTRP operation and applies both TCI states. In another embodiment, if the DCI indicator field is RRC configured to be not present, dynamic switching between sTRP operation and mTRP operation is not supported. In one example, the STRP/mTRP switching is done on the basis of the MAC-CE activated TCI state mapping. If the MAC-CE activates any of the 8 TCI codepoints with more than one joint/DL/UL TCI state, the UE can assume mTRP operation and only if all codepoints are mapped to single joint/DL/UL or one DL+one UL TCI state, the UE can assume sTRP operation. In another embodiment, when RRC configures the DCI indicator field to be not present in the DCI, UE expects RRC to also configure sTRP or mTRP operation mode i.e., semi-static switching between sTRP and mTRP modes is expected.

In another embodiment, when the DCI indicator field is configured by RRC to be not present, and the DCI schedules or activates a PDSCH reception such that the scheduling offset is below a threshold which is required for the UE to decode the DCI and interpret the DCI indicator field, if the UE reports a capability of supporting two default beams in FR2, the UE is expected to apply both the beams to buffer the data. In one example, the default beams are the indicated DL/UL/joint TCI states which are active at the time when the PDSCH reception begins. In one embodiment, the UE is not expected to change beams until after the end of the PDSCH reception if the PDSCH reception begins before a threshold and the last symbol of the scheduled PDSCH occurs after the threshold. In another embodiment, the UE changes to the two beams indicated by the scheduling DCI at the first slot boundary which occurs after the threshold. In one embodiment, if the UE does not report a capability of supporting two default beams, the UE does not expect to be scheduled with a S-DCI mTRP PDSCH/PUSCH starting before a threshold from the last symbol of the scheduling DCI.

For beam failure recovery purposes, a set of beam failure detection RSs may be implicitly determined by the UE based on activated and or indicated joint/DL TCI states. In one embodiment, for activated TCI codepoints mapped to two TCI states, the UE may assume that the set of TCIs which are mapped as the first TCI state in a codepoint are part of a 1st BFD-RS set and the set of TCI states mapped as the second TCI states in codepoint are part of a second BFD-RS set. Each BFD-RS set can correspond to a different TRP. In another embodiment, the value of the ID associated with the TCI state mapped to a codepoint can have one-to-one correspondence with the BFD-RS set ID i.e., the ID or IDs configured to the activated TCI codepoints by MAC-CE indicates which BFD-RS sets these TCI states belong to. In another embodiment, there can be a one-to-one correspondence between BFD-RS sets and coresetPoolIndex for single-DCI multi-TRP. In one embodiment, if the number of BFD-RSs determined implicitly exceeds the number of BFD-RSs that can be supported by the UE per BFD-RS set, the UE can assume that only the first N unique TCI states in the BFD-RS set are valid where N is the maximum number of BFD-RSs per BFD-RS set that can be supported by the UE.

In one embodiment, for single DCI based PUCCH transmission, a PUCCH resource or resource group can be configured by RRC to be associated with one of the IDs configured by the TCI activation MAC-CE. Depending on the associated ID, the PUCCH resource follows corresponding TCI state when a codepoint is indicated. In one embodiment, if a TCI codepoint is indicated by DCI which updates the TCI state (joint/DL/UL) for only one TRP or corresponds to only one ID, the PUCCH resource or resource groups which are RRC configured to be associated with the other TRP or other ID or with a TCI state group that is not updated, the respective PUCCH resource continues to follow the last activated TCI state.

For, Beam Failure Recovery Response, in one embodiment, for single-DCI multi-TRP, the beam failure recovery MAC-CE also indicates the ID value of the failed TRP and the new beam if found also corresponds to the same ID value. In one example, this ID value may be replaced by a TCI state group. The UE is expected to apply the new TCI indicated by the BFR response PDCCH to all the signals/channels which shared the TCI state to the corresponding TRP.

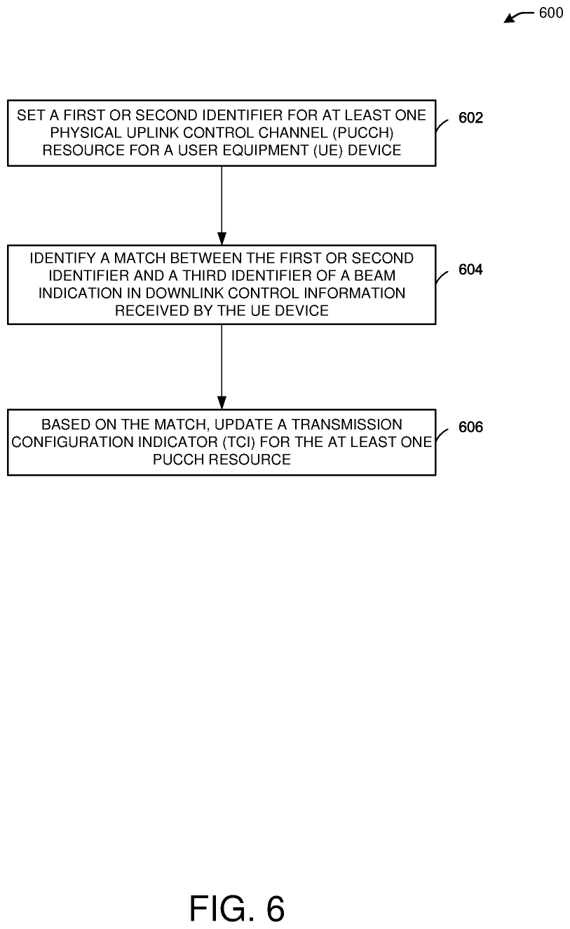

FIG. 6 illustrates a flow diagram of illustrative process for beam signaling, beam failure recovery (BFR), a transmission configuration indicator (TCI), and multiple transmit/receive point (multi-TRP) operations, in accordance with one or more example embodiments of the present disclosure.

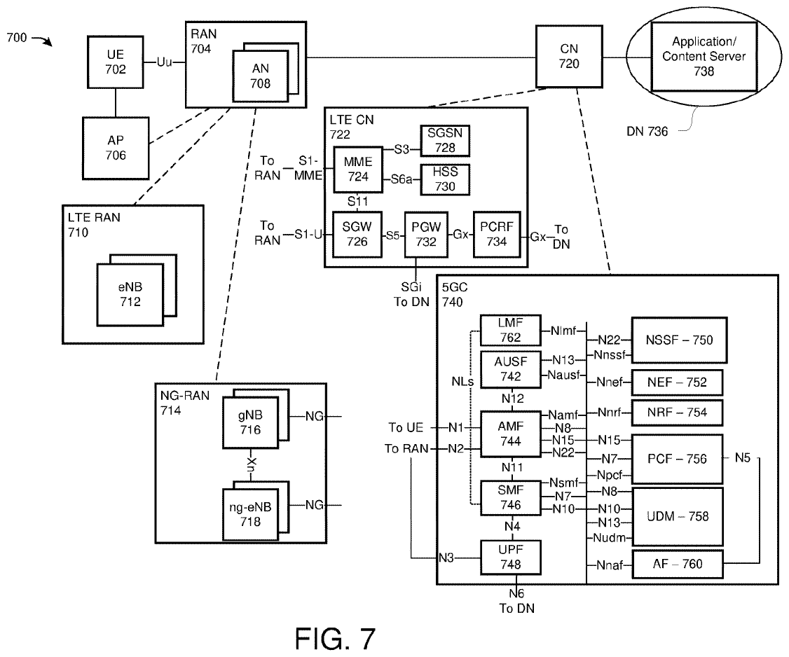

At block 602, a device (or system, e.g., any of the UEs 120 of FIG. 1, the UE 702 of FIG. 7) may set a first identifier or second identifier (e.g., corsetpoolindex value or other identifier) for at least one PUCCH resource for the device.

At block 604, the device may identify a match between the first identifier or the second identifier and a third identifier of a beam indication in DCI received by the device.

At block 606, the device may, only when there is a match at block 604, update a TCI for the at least one PUCCH resource.

These embodiments are not meant to be limiting.

FIG. 7 illustrates a network 700 in accordance with various embodiments. The network 700 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 700 may include a UE 702, which may include any mobile or non-mobile computing device designed to communicate with a RAN 704 via an over-the-air connection. The UE 702 may be communicatively coupled with the RAN 704 by a Uu interface. The UE 702 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 700 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 702 may additionally communicate with an AP 706 via an over-the-air connection. The AP 706 may manage a WLAN connection, which may serve to offload some/all network traffic from the RAN 704. The connection between the UE 702 and the AP 706 may be consistent with any IEEE 802.11 protocol, wherein the AP 706 could be a wireless fidelity (Wi-Fi®) router. In some embodiments, the UE 702, RAN 704, and AP 706 may utilize cellular-WLAN aggregation (for example, LWA/LWIP). Cellular-WLAN aggregation may involve the UE 702 being configured by the RAN 704 to utilize both cellular radio resources and WLAN resources.

The RAN 704 may include one or more access nodes, for example, AN 708. AN 708 may terminate air-interface protocols for the UE 702 by providing access stratum protocols including RRC, PDCP, RLC, MAC, and L1 protocols. In this manner, the AN 708 may enable data/voice connectivity between CN 720 and the UE 702. In some embodiments, the AN 708 may be implemented in a discrete device or as one or more software entities running on server computers as part of, for example, a virtual network, which may be referred to as a CRAN or virtual baseband unit pool. The AN 708 be referred to as a BS, gNB, RAN node, eNB, ng-eNB, NodeB, RSU, TRxP, TRP, etc. The AN 708 may be a macrocell base station or a low power base station for providing femtocells, picocells or other like cells having smaller coverage areas, smaller user capacity, or higher bandwidth compared to macrocells.

In embodiments in which the RAN 704 includes a plurality of ANs, they may be coupled with one another via an X2 interface (if the RAN 704 is an LTE RAN) or an Xn interface (if the RAN 704 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 704 may each manage one or more cells, cell groups, component carriers, etc. to provide the UE 702 with an air interface for network access. The UE 702 may be simultaneously connected with a plurality of cells provided by the same or different ANs of the RAN 704. For example, the UE 702 and RAN 704 may use carrier aggregation to allow the UE 702 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 704 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 702 or AN 708 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 704 may be an LTE RAN 710 with eNBs, for example, eNB 712. The LTE RAN 710 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 704 may be an NG-RAN 714 with gNBs, for example, gNB 716, or ng-eNBs, for example, ng-eNB 718. The gNB 716 may connect with 5G-enabled UEs using a 5G NR interface. The gNB 716 may connect with a 5G core through an NG interface, which may include an N2 interface or an N3 interface. The ng-eNB 718 may also connect with the 5G core through an NG interface, but may connect with a UE via an LTE air interface. The gNB 716 and the ng-eNB 718 may connect with each other over an Xn interface.

In some embodiments, the NG interface may be split into two parts, an NG user plane (NG-U) interface, which carries traffic data between the nodes of the NG-RAN 714 and a UPF 748 (e.g., N3 interface), and an NG control plane (NG-C) interface, which is a signaling interface between the nodes of the NG-RAN 714 and an AMF 744 (e.g., N2 interface).

The NG-RAN 714 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FRI bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 702 can be configured with multiple BWPs where each BWP configuration has a different SCS. When a BWP change is indicated to the UE 702, the SCS of the transmission is changed as well. Another use case example of BWP is related to power saving. In particular, multiple BWPs can be configured for the UE 702 with different amount of frequency resources (for example, PRBs) to support data transmission under different traffic loading scenarios. A BWP containing a smaller number of PRBs can be used for data transmission with small traffic load while allowing power saving at the UE 702 and in some cases at the gNB 716. A BWP containing a larger number of PRBs can be used for scenarios with higher traffic load.

The RAN 704 is communicatively coupled to CN 720 that includes network elements to provide various functions to support data and telecommunications services to customers/subscribers (for example, users of UE 702). The components of the CN 720 may be implemented in one physical node or separate physical nodes. In some embodiments, NFV may be utilized to virtualize any or all of the functions provided by the network elements of the CN 720 onto physical compute/storage resources in servers, switches, etc. A logical instantiation of the CN 720 may be referred to as a network slice, and a logical instantiation of a portion of the CN 720 may be referred to as a network sub-slice.

In some embodiments, the CN 720 may be an LTE CN 722, which may also be referred to as an EPC. The LTE CN 722 may include MME 724, SGW 726, SGSN 728, HSS 730, PGW 732, and PCRF 734 coupled with one another over interfaces (or “reference points”) as shown. Functions of the elements of the LTE CN 722 may be briefly introduced as follows.

The MME 724 may implement mobility management functions to track a current location of the UE 702 to facilitate paging, bearer activation/deactivation, handovers, gateway selection, authentication, etc.

The SGW 726 may terminate an S1 interface toward the RAN and route data packets between the RAN and the LTE CN 722. The SGW 726 may be a local mobility anchor point for inter-RAN node handovers and also may provide an anchor for inter-3GPP mobility. Other responsibilities may include lawful intercept, charging, and some policy enforcement.

The SGSN 728 may track a location of the UE 702 and perform security functions and access control. In addition, the SGSN 728 may perform inter-EPC node signaling for mobility between different RAT networks; PDN and S-GW selection as specified by MME 724; MME selection for handovers; etc. The S3 reference point between the MME 724 and the SGSN 728 may enable user and bearer information exchange for inter-3GPP access network mobility in idle/active states.

The HSS 730 may include a database for network users, including subscription-related information to support the network entities' handling of communication sessions. The HSS 730 can provide support for routing/roaming, authentication, authorization, naming/addressing resolution, location dependencies, etc. An S6a reference point between the HSS 730 and the MME 724 may enable transfer of subscription and authentication data for authenticating/authorizing user access to the LTE CN 720.

The PGW 732 may terminate an SGi interface toward a data network (DN) 736 that may include an application/content server 738. The PGW 732 may route data packets between the LTE CN 722 and the data network 736. The PGW 732 may be coupled with the SGW 726 by an S5 reference point to facilitate user plane tunneling and tunnel management. The PGW 732 may further include a node for policy enforcement and charging data collection (for example, PCEF). Additionally, the SGi reference point between the PGW 732 and the data network 736 may be an operator external public, a private PDN, or an intra-operator packet data network, for example, for provision of IMS services. The PGW 732 may be coupled with a PCRF 734 via a Gx reference point.

The PCRF 734 is the policy and charging control element of the LTE CN 722. The PCRF 734 may be communicatively coupled to the app/content server 738 to determine appropriate QoS and charging parameters for service flows. The PCRF 732 may provision associated rules into a PCEF (via Gx reference point) with appropriate TFT and QCI.

In some embodiments, the CN 720 may be a 5GC 740. The 5GC 740 may include an AUSF 742, AMF 744, SMF 746, UPF 748, NSSF 750, NEF 752, NRF 754, PCF 756, UDM 758, and AF 760 coupled with one another over interfaces (or “reference points”) as shown. Functions of the elements of the 5GC 740 may be briefly introduced as follows.

The AUSF 742 may store data for authentication of UE 702 and handle authentication-related functionality. The AUSF 742 may facilitate a common authentication framework for various access types. In addition to communicating with other elements of the 5GC 740 over reference points as shown, the AUSF 742 may exhibit an Nausf service-based interface.

The AMF 744 may allow other functions of the 5GC 740 to communicate with the UE 702 and the RAN 704 and to subscribe to notifications about mobility events with respect to the UE 702. The AMF 744 may be responsible for registration management (for example, for registering UE 702), connection management, reachability management, mobility management, lawful interception of AMF-related events, and access authentication and authorization. The AMF 744 may provide transport for SM messages between the UE 702 and the SMF 746, and act as a transparent proxy for routing SM messages. AMF 744 may also provide transport for SMS messages between UE 702 and an SMSF. AMF 744 may interact with the AUSF 742 and the UE 702 to perform various security anchor and context management functions. Furthermore, AMF 744 may be a termination point of a RAN CP interface, which may include or be an N2 reference point between the RAN 704 and the AMF 744; and the AMF 744 may be a termination point of NAS (N1) signaling, and perform NAS ciphering and integrity protection. AMF 744 may also support NAS signaling with the UE 702 over an N3 IWF interface.

The SMF 746 may be responsible for SM (for example, session establishment, tunnel management between UPF 748 and AN 708); UE IP address allocation and management (including optional authorization); selection and control of UP function; configuring traffic steering at UPF 748 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 744 over N2 to AN 708; and determining SSC mode of a session. SM may refer to management of a PDU session, and a PDU session or “session” may refer to a PDU connectivity service that provides or enables the exchange of PDUs between the UE 702 and the data network 736.

The UPF 748 may act as an anchor point for intra-RAT and inter-RAT mobility, an external PDU session point of interconnect to data network 736, and a branching point to support multi-homed PDU session. The UPF 748 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 748 may include an uplink classifier to support routing traffic flows to a data network.

The NSSF 750 may select a set of network slice instances serving the UE 702. The NSSF 750 may also determine allowed NSSAI and the mapping to the subscribed S-NSSAIs, if needed. The NSSF 750 may also determine the AMF set to be used to serve the UE 702, or a list of candidate AMFs based on a suitable configuration and possibly by querying the NRF 754. The selection of a set of network slice instances for the UE 702 may be triggered by the AMF 744 with which the UE 702 is registered by interacting with the NSSF 750, which may lead to a change of AMF. The NSSF 750 may interact with the AMF 744 via an N22 reference point; and may communicate with another NSSF in a visited network via an N31 reference point (not shown). Additionally, the NSSF 750 may exhibit an Nnssf service-based interface.

The NEF 752 may securely expose services and capabilities provided by 3GPP network functions for third party, internal exposure/re-exposure, AFs (e.g., AF 760), edge computing or fog computing systems, etc. In such embodiments, the NEF 752 may authenticate, authorize, or throttle the AFs. NEF 752 may also translate information exchanged with the AF 760 and information exchanged with internal network functions. For example, the NEF 752 may translate between an AF-Service-Identifier and an internal 5GC information. NEF 752 may also receive information from other NFs based on exposed capabilities of other NFs. This information may be stored at the NEF 752 as structured data, or at a data storage NF using standardized interfaces. The stored information can then be re-exposed by the NEF 752 to other NFs and AFs, or used for other purposes such as analytics. Additionally, the NEF 752 may exhibit an Nnef service-based interface.

The NRF 754 may support service discovery functions, receive NF discovery requests from NF instances, and provide the information of the discovered NF instances to the NF instances. NRF 754 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1054 may exhibit the Nnrf service-based interface.

The PCF 756 may provide policy rules to control plane functions to enforce them, and may also support unified policy framework to govern network behavior. The PCF 756 may also implement a front end to access subscription information relevant for policy decisions in a UDR of the UDM 758. In addition to communicating with functions over reference points as shown, the PCF 756 exhibit an Npcf service-based interface.

The UDM 758 may handle subscription-related information to support the network entities' handling of communication sessions, and may store subscription data of UE 702. For example, subscription data may be communicated via an N8 reference point between the UDM 758 and the AMF 744. The UDM 758 may include two parts, an application front end and a UDR. The UDR may store subscription data and policy data for the UDM 758 and the PCF 756, and/or structured data for exposure and application data (including PFDs for application detection, application request information for multiple UEs 702) for the NEF 752. The Nudr service-based interface may be exhibited by the UDR to allow the UDM 758, PCF 756, and NEF 752 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 758 may exhibit the Nudm service-based interface.

The AF 760 may provide application influence on traffic routing, provide access to NEF, and interact with the policy framework for policy control.

In some embodiments, the 5GC 740 may enable edge computing by selecting operator/3^{rd} party services to be geographically close to a point that the UE 702 is attached to the network. This may reduce latency and load on the network. To provide edge-computing implementations, the 5GC 740 may select a UPF 748 close to the UE 702 and execute traffic steering from the UPF 748 to data network 736 via the N6 interface. This may be based on the UE subscription data, UE location, and information provided by the AF 760. In this way, the AF 760 may influence UPF (re) selection and traffic routing. Based on operator deployment, when AF 760 is considered to be a trusted entity, the network operator may permit AF 760 to interact directly with relevant NFs. Additionally, the AF 760 may exhibit an Naf service-based interface.

The data network 736 may represent various network operator services, Internet access, or third party services that may be provided by one or more servers including, for example, application/content server 738.

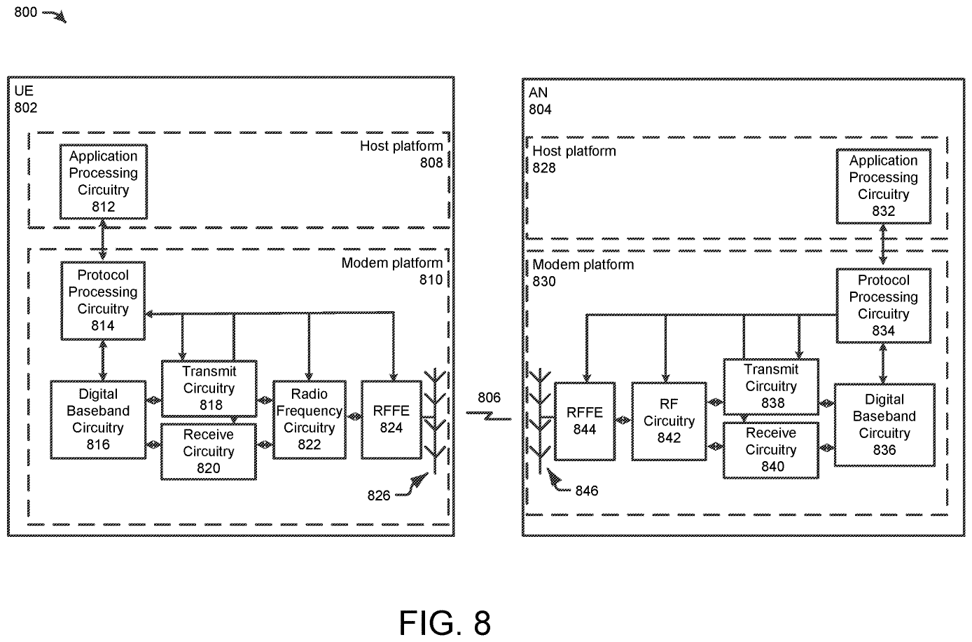

FIG. 8 schematically illustrates a wireless network 800 in accordance with various embodiments. The wireless network 800 may include a UE 802 in wireless communication with an AN 804. The UE 802 and AN 804 may be similar to, and substantially interchangeable with, like-named components described elsewhere herein.

The UE 802 may be communicatively coupled with the AN 804 via connection 806. The connection 806 is illustrated as an air interface to enable communicative coupling, and can be consistent with cellular communications protocols such as an LTE protocol or a 5G NR protocol operating at mmWave or sub-6 GHZ frequencies.

The UE 802 may include a host platform 808 coupled with a modem platform 810. The host platform 808 may include application processing circuitry 812, which may be coupled with protocol processing circuitry 814 of the modem platform 810. The application processing circuitry 812 may run various applications for the UE 802 that source/sink application data. The application processing circuitry 812 may further implement one or more layer operations to transmit/receive application data to/from a data network. These layer operations may include transport (for example UDP) and Internet (for example, IP) operations

The protocol processing circuitry 814 may implement one or more of layer operations to facilitate transmission or reception of data over the connection 806. The layer operations implemented by the protocol processing circuitry 814 may include, for example, MAC, RLC, PDCP, RRC and NAS operations.

The modem platform 810 may further include digital baseband circuitry 816 that may implement one or more layer operations that are “below” layer operations performed by the protocol processing circuitry 1114 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 810 may further include transmit circuitry 818, receive circuitry 820, RF circuitry 822, and RF front end (RFFE) 824, which may include or connect to one or more antenna panels 826. Briefly, the transmit circuitry 818 may include a digital-to-analog converter, mixer, intermediate frequency (IF) components, etc.; the receive circuitry 820 may include an analog-to-digital converter, mixer, IF components, etc.; the RF circuitry 822 may include a low-noise amplifier, a power amplifier, power tracking components, etc.; RFFE 824 may include filters (for example, surface/bulk acoustic wave filters), switches, antenna tuners, beamforming components (for example, phase-array antenna components), etc. The selection and arrangement of the components of the transmit circuitry 818, receive circuitry 820, RF circuitry 822, RFFE 824, and antenna panels 826 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 814 may include one or more instances of control circuitry (not shown) to provide control functions for the transmit/receive components.

A UE reception may be established by and via the antenna panels 826, RFFE 84, RF circuitry 822, receive circuitry 820, digital baseband circuitry 816, and protocol processing circuitry 814. In some embodiments, the antenna panels 826 may receive a transmission from the AN 804 by receive-beamforming signals received by a plurality of antennas/antenna elements of the one or more antenna panels 826.

A UE transmission may be established by and via the protocol processing circuitry 814, digital baseband circuitry 816, transmit circuitry 818, RF circuitry 822, RFFE 824, and antenna panels 826. In some embodiments, the transmit components of the UE 804 may apply a spatial filter to the data to be transmitted to form a transmit beam emitted by the antenna elements of the antenna panels 826.

Similar to the UE 802, the AN 804 may include a host platform 828 coupled with a modem platform 830. The host platform 828 may include application processing circuitry 832 coupled with protocol processing circuitry 834 of the modem platform 830. The modem platform may further include digital baseband circuitry 836, transmit circuitry 838, receive circuitry 840, RF circuitry 842, RFFE circuitry 844, and antenna panels 846. The components of the AN 804 may be similar to and substantially interchangeable with like-named components of the UE 802. In addition to performing data transmission/reception as described above, the components of the AN 808 may perform various logical functions that include, for example, RNC functions such as radio bearer management, uplink and downlink dynamic radio resource management, and data packet scheduling.

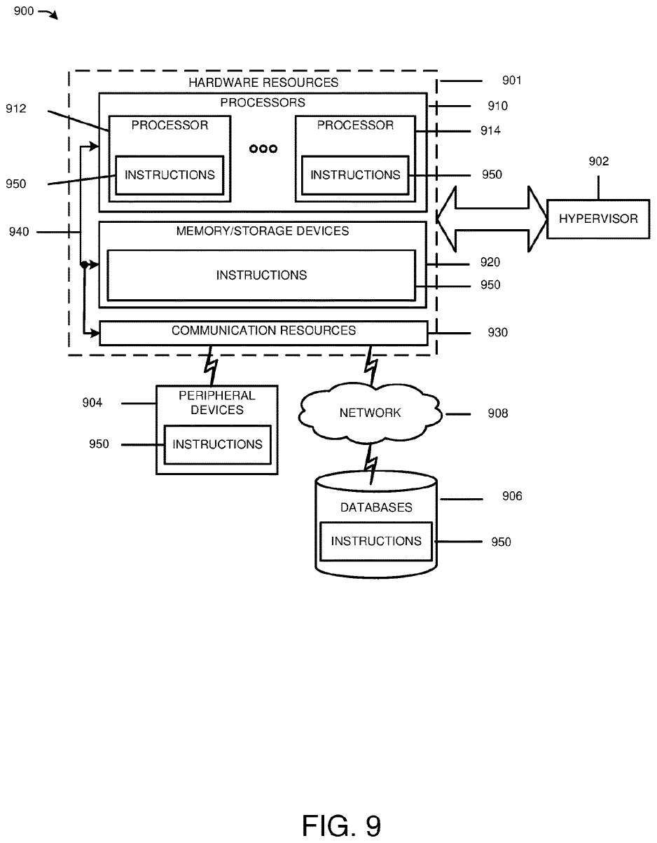

FIG. 9 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 9 shows a diagrammatic representation of hardware resources 900 including one or more processors (or processor cores) 910, one or more memory/storage devices 920, and one or more communication resources 930, each of which may be communicatively coupled via a bus 940 or other interface circuitry. For embodiments where node virtualization (e.g., NFV) is utilized, a hypervisor 902 may be executed to provide an execution environment for one or more network slices/sub-slices to utilize the hardware resources 900.

The processors 910 may include, for example, a processor 912 and a processor 914. The processors 910 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 920 may include main memory, disk storage, or any suitable combination thereof. The memory/storage devices 920 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 930 may include interconnection or network interface controllers, components, or other suitable devices to communicate with one or more peripheral devices 904 or one or more databases 906 or other network elements via a network 908. For example, the communication resources 930 may include wired communication components (e.g., for coupling via USB, Ethernet, etc.), cellular communication components, NFC components, Bluetooth® (or Bluetooth® Low Energy) components, Wi-Fi® components, and other communication components.

Instructions 950 may comprise software, a program, an application, an applet, an app, or other executable code for causing at least any of the processors 910 to perform any one or more of the methodologies discussed herein. The instructions 950 may reside, completely or partially, within at least one of the processors 910 (e.g., within the processor's cache memory), the memory/storage devices 920, or any suitable combination thereof. Furthermore, any portion of the instructions 950 may be transferred to the hardware resources 900 from any combination of the peripheral devices 904 or the databases 906. Accordingly, the memory of processors 910, the memory/storage devices 920, the peripheral devices 904, and the databases 906 are examples of computer-readable and machine-readable media.

FIG. 10 illustrates a network 1000, in accordance with one or more example embodiments of the present disclosure.

The network 1000 may operate in a matter consistent with 3GPP technical specifications or technical reports for 6G systems. In some embodiments, the network 1000 may operate concurrently with network YX00. For example, in some embodiments, the network 1000 may share one or more frequency or bandwidth resources with network YX00. As one specific example, a UE (e.g., UE 1002) may be configured to operate in both network 1000 and network YX00. Such configuration may be based on a UE including circuitry configured for communication with frequency and bandwidth resources of both networks YX00 and 1000. In general, several elements of network 1000 may share one or more characteristics with elements of network YX00. For the sake of brevity and clarity, such elements may not be repeated in the description of network 1000.

The network 1000 may include a UE 1002, which may include any mobile or non-mobile computing device designed to communicate with a RAN 1008 via an over-the-air connection. The UE 1002 may be similar to, for example, UE YX02. The UE 1002 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 10, in some embodiments the network 1000 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 10, the UE 1002 may be communicatively coupled with an AP such as AP YX06 as described with respect to Figure YX. Additionally, although not specifically shown in FIG. 10, in some embodiments the RAN 1008 may include one or more ANss such as AN YX08 as described with respect to Figure YX. The RAN 1008 and/or the AN of the RAN 1008 may be referred to as a base station (BS), a RAN node, or using some other term or name.

The UE 1002 and the RAN 1008 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mm Wave” frequency ranges.

The RAN 1008 may allow for communication between the UE 1002 and a 6G core network (CN) 1010. Specifically, the RAN 1008 may facilitate the transmission and reception of data between the UE 1002 and the 6G CN 1010. The 6G CN 1010 may include various functions such as NSSF YX50, NEF YX52, NRF YX54, PCF YX56, UDM YX58, AF YX60, SMF YX46, and AUSF YX42. The 6G CN 1010 may additional include UPF YX48 and DN YX36 as shown in FIG. 10.

Additionally, the RAN 1008 may include various additional functions that are in addition to, or alternative to, functions of a legacy cellular network such as a 4G or 5G network. Two such functions may include a Compute Control Function (Comp CF) 1024 and a Compute Service Function (Comp SF) 1036. The Comp CF 1024 and the Comp SF 1036 may be parts or functions of the Computing Service Plane. Comp CF 1024 may be a control plane function that provides functionalities such as management of the Comp SF 1036, computing task context generation and management (e.g., create, read, modify, delete), interaction with the underlaying computing infrastructure for computing resource management, etc. Comp SF 1036 may be a user plane function that serves as the gateway to interface computing service users (such as UE 1002) and computing nodes behind a Comp SF instance. Some functionalities of the Comp SF 1036 may include: parse computing service data received from users to compute tasks executable by computing nodes; hold service mesh ingress gateway or service API gateway; service and charging policies enforcement; performance monitoring and telemetry collection, etc. In some embodiments, a Comp SF 1036 instance may serve as the user plane gateway for a cluster of computing nodes. A Comp CF 1024 instance may control one or more Comp SF 1036 instances.

Two other such functions may include a Communication Control Function (Comm CF) 1028 and a Communication Service Function (Comm SF) 1038, which may be parts of the Communication Service Plane. The Comm CF 1028 may be the control plane function for managing the Comm SF 1038, communication sessions creation/configuration/releasing, and managing communication session context. The Comm SF 1038 may be a user plane function for data transport. Comm CF 1028 and Comm SF 1038 may be considered as upgrades of SMF YX46 and UPF YX48, which were described with respect to a 5G system in Figure YX. The upgrades provided by the Comm CF 1028 and the Comm SF 1038 may enable service-aware transport. For legacy (e.g., 4G or 5G) data transport, SMF YX46 and UPF YX48 may still be used.

Two other such functions may include a Data Control Function (Data CF) 1022 and Data Service Function (Data SF) 1032 may be parts of the Data Service Plane. Data CF 1022 may be a control plane function and provides functionalities such as Data SF 1032 management, Data service creation/configuration/releasing, Data service context management, etc. Data SF 1032 may be a user plane function and serve as the gateway between data service users (such as UE 1002 and the various functions of the 6G CN 1010) and data service endpoints behind the gateway. Specific functionalities may include include: parse data service user data and forward to corresponding data service endpoints, generate charging data, report data service status.

Another such function may be the Service Orchestration and Chaining Function (SOCF) 1020, which may discover, orchestrate and chain up communication/computing/data services provided by functions in the network. Upon receiving service requests from users, SOCF 1020 may interact with one or more of Comp CF 1024, Comm CF 1028, and Data CF 1022 to identify Comp SF 1036, Comm SF 1038, and Data SF 1032 instances, configure service resources, and generate the service chain, which could contain multiple Comp SF 1036, Comm SF 1038, and Data SF 1032 instances and their associated computing endpoints. Workload processing and data movement may then be conducted within the generated service chain. The SOCF 1020 may also responsible for maintaining, updating, and releasing a created service chain.

Another such function may be the service registration function (SRF) 1014, which may act as a registry for system services provided in the user plane such as services provided by service endpoints behind Comp SF 1036 and Data SF 1032 gateways and services provided by the UE 1002. The SRF 1014 may be considered a counterpart of NRF YX54, which may act as the registry for network functions.

Other such functions may include an evolved service communication proxy (eSCP) and service infrastructure control function (SICF) 1026, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 1012 and eSCP-U 1034, for control plane service communication proxy and user plane service communication proxy, respectively. The SICF 1026 may control and configure eCSP instances in terms of service traffic routing policies, access rules, load balancing configurations, performance monitoring, etc.

Another such function is the AMF 1044. The AMF 1044 may be similar to YX44, but with additional functionality. Specifically, the AMF 1044 may include potential functional repartition, such as move the message forwarding functionality from the AMF 1044 to the RAN 1008.

Another such function is the service orchestration exposure function (SOEF) 1018. The SOEF may be configured to expose service orchestration and chaining services to external users such as applications.

The UE 1002 may include an additional function that is referred to as a computing client service function (comp CSF) 1004. The comp CSF 1004 may have both the control plane functionalities and user plane functionalities, and may interact with corresponding network side functions such as SOCF 1020, Comp CF 1024, Comp SF 1036, Data CF 1022, and/or Data SF 1032 for service discovery, request/response, compute task workload exchange, etc. The Comp CSF 1004 may also work with network side functions to decide on whether a computing task should be run on the UE 1002, the RAN 1008, and/or an element of the 6G CN 1010.

The UE 1002 and/or the Comp CSF 1004 may include a service mesh proxy 1006. The service mesh proxy 1006 may act as a proxy for service-to-service communication in the user plane. Capabilities of the service mesh proxy 1006 may include one or more of addressing, security, load balancing, etc.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section. The following examples pertain to further embodiments.

Example 1 may include an apparatus of a user equipment (UE) device for beam indication, beam failure recovery (BFR), a transmission configuration indicator (TCI), and multiple transmit/receive point (multi-TRP) operations, the apparatus comprising processing circuitry coupled to storage for storing information associated with the configuring, the processing circuitry configured to: set, using a configuration of a network protocol layer higher than a medium access control (MAC) layer, a first identifier or a second identifier for at least one physical uplink control channel (PUCCH) resource; identify a match between the first identifier or the second identifier and a third identifier of a beam indication in downlink control information (DCI) received by the UE device; and based on the match, update a transmission configuration indicator (TCI) for the at least one PUCCH resource.

Example 2 may include the apparatus of example 1 and/or any other example herein, wherein the TCI is updated based on the third identifier.

Example 3 may include the apparatus of example 1 and/or any other example herein, wherein before the TCI is updated, the TCI is indicated by a PUCCH resource indicator (PRI).

Example 4 may include the apparatus of example 1 and/or any other example herein, wherein the processing circuitry is further configured to: detect, in a medium access control (MAC) control element (MAC-CE) for TCI state activation for a single DCI-based multi-TRP transmission, an identifier corresponding to one or more mapped TCI states to a codepoint indicative of which TRP to which a mapped TCI state applies.

Example 5 may include the apparatus of example 4 and/or any other example herein, wherein the identifier may be a TCI state group, a coresetpoolindex value, or another identifier comprising multiple values.

Example 6 may include the apparatus of example 1 and/or any other example herein, wherein for a beam failure detection resource set determination, the processing circuitry is further configured to: set first TCI states mapped to a first identifier value as part of a first beam failure detection resource set; and set second TCI states mapped to a second identifier value as part of a second beam failure detection resource set.

Example 7 may include the apparatus of example 1 and/or any other example herein, wherein for a PUCCH transmission in a single DCI-based multi-TRP operation, the processing circuitry is further configured to: set the PUCCH resource, using a radio resource control message, to correspond to an identifier value or a TCI state group; set a first PUCCH resource group to correspond to TCI states mapped as first TCI states in a codepoint; and set a second PUCCH resource group to correspond to TCI states mapped as second TCI states in the codepoint, wherein when a beam indication DCI updates at least one TCI, only PUCCH resources corresponding to associated TCI states update spatial filters.

Example 8 may include a computer-readable storage medium comprising instructions to cause processing circuitry of a user equipment (UE) device for beam indication, beam failure recovery (BFR), a transmission configuration indicator (TCI), and multiple transmit/receive point (multi-TRP) operations, upon execution of the instructions by the processing circuitry, to: set, using a configuration of a network protocol layer higher than a medium access control (MAC) layer, a first identifier or a second identifier for at least one physical uplink control channel (PUCCH) resource; identify a match between the first identifier or the second identifier and a third identifier of a beam indication in downlink control information (DCI) received by the UE device; and based on the match, update a transmission configuration indicator (TCI) for the at least one PUCCH resource.

Example 9 may include the computer-readable storage medium of example 8 and/or any other example herein, wherein the TCI is updated based on the third identifier.

Example 10 may include the computer-readable storage medium of example 8 and/or any other example herein, wherein before the TCI is updated, the TCI is indicated by a PUCCH resource indicator (PRI).

Example 11 may include the computer-readable storage medium of example 8, wherein execution of the instructions further causes the processing circuitry to: detect, in a medium access control (MAC) control element (MAC-CE) for TCI state activation for a single DCI-based multi-TRP transmission, an identifier corresponding to one or more mapped TCI states to a codepoint indicative of which TRP to which a mapped TCI state applies.

Example 12 may include the computer-readable storage medium of example 11 and/or any other example herein, wherein the identifier may be a TCI state group, a coresetpoolindex value, or another identifier comprising multiple values.

Example 13 may include the computer-readable storage medium of example 8 and/or any other example herein, wherein for a beam failure detection resource set determination, execution of the instructions further causes the processing circuitry to: set first TCI states mapped to a first identifier value as part of a first beam failure detection resource set; and set second TCI states mapped to a second identifier value as part of a second beam failure detection resource set.

Example 14 may include the computer-readable storage medium of example 8 and/or any other example herein, wherein for a PUCCH transmission in a single DCI-based multi-TRP operation, execution of the instructions further causes the processing circuitry to: set the PUCCH resource, using a radio resource control message, to correspond to an identifier value or a TCI state group; set a first PUCCH resource group to correspond to TCI states mapped as first TCI states in a codepoint; and set a second PUCCH resource group to correspond to TCI states mapped as second TCI states in the codepoint, wherein when a beam indication DCI updates at least one TCI, only PUCCH resources corresponding to associated TCI states update spatial filters.

Example 15 may include the a method for beam indication, beam failure recovery (BFR), a transmission configuration indicator (TCI), and multiple transmit/receive point (multi-TRP) operations, the method comprising: setting, by processing circuitry of a user equipment (UE) device, using a configuration of a network protocol layer higher than a medium access control (MAC) layer, a first identifier or a second identifier for at least one physical uplink control channel (PUCCH) resource; identifying, by the processing circuitry, a match between the first identifier or the second identifier and a third identifier of a beam indication in downlink control information (DCI) received by the UE device; and based on the match, updating, by the processing circuitry, a transmission configuration indicator (TCI) for the at least one PUCCH resource.

Example 16 may include the method of example 15 and/or any other example herein, wherein the TCI is updated based on the third identifier.

Example 17 may include the method of example 15 and/or any other example herein, wherein before the TCI is updated, the TCI is indicated by a PUCCH resource indicator (PRI).

Example 18 the method of example 15 and/or any other example herein, further comprising: detecting, in a medium access control (MAC) control element (MAC-CE) for TCI state activation for a single DCI-based multi-TRP transmission, an identifier corresponding to one or more mapped TCI states to a codepoint indicative of which TRP to which a mapped TCI state applies.

Example 19 may include the method of example 15 and/or any other example herein, wherein the identifier may be a TCI state group, a coresetpoolindex value, or another identifier comprising multiple values.

Example 20 may include the method of example 15 and/or any other example herein, wherein for a beam failure detection resource set determination, the method further comprises: setting first TCI states mapped to a first identifier value as part of a first beam failure detection resource set; and setting second TCI states mapped to a second identifier value as part of a second beam failure detection resource set.

Example 21 may include the method of example 15 and/or any other example herein, wherein for a PUCCH transmission in a single DCI-based multi-TRP operation, the method further comprising: setting the PUCCH resource, using a radio resource control message, to correspond to an identifier value or a TCI state group; setting a first PUCCH resource group to correspond to TCI states mapped as first TCI states in a codepoint; and setting a second PUCCH resource group to correspond to TCI states mapped as second TCI states in the codepoint, wherein when a beam indication DCI updates at least one TCI, only PUCCH resources corresponding to associated TCI states update spatial filters.

Example 22 may include an apparatus including means for: setting, by a user equipment (UE) device, using a configuration of a network protocol layer higher than a medium access control (MAC) layer, a first identifier or a second identifier for at least one physical uplink control channel (PUCCH) resource; identifying a match between the first identifier or the second identifier and a third identifier of a beam indication in downlink control information (DCI) received by the UE device; and based on the match, updating a transmission configuration indicator (TCI) for the at least one PUCCH resource.

Example 23 may include a method of communicating in a wireless network as shown and described herein.

Example 24 may include a system for providing wireless communication as shown and described herein.

Example 25 may include a device for providing wireless communication as shown and described herein.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Various embodiments are described below.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can.” “could.” “might.” or “may.” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

Unless used differently herein, terms, definitions, and abbreviations may be consistent with terms, definitions, and abbreviations defined in 3GPP TR 21.905 v16.0.0 (2019-06) and/or any other 3GPP standard. For the purposes of the present document, the following abbreviations (shown in Table 1) may apply to the examples and embodiments discussed herein.

TABLE 1
Abbreviations

| | |
|---|---|
| 3GPP | Third Generation Partnership Project |
| 4G | Fourth Generation |
| 5G | Fifth Generation |
| 5GC | 5G Core network |
| AC | Application Client |
| ACK | Acknowledgement |
| ACID | Application Client Identification |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AP | Application Protocol, |
| | Antenna Port, |
| | Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, |
| | Certification Authority |
| CAPEX | CAPital Expenditure |
| CBRA | Contention Based Random Access |
| CC | Component Carrier, |
| | Country Code, |
| | Cryptographic Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CFRA | Contention Free Random Access |
| CG | Cell Group |
| CGF | Charging Gateway Function |
| CHF | Charging Function |
| CI | Cell Identity |
| CID | Cell-ID (e.g., positioning method) |
| CIM | Common Information Model |
| CIR | Carrier to Interference Ratio |
| CK | Cipher Key |
| CM | Connection Management, |
| | Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, |
| | Cyclic Prefix, |
| | Connection Point |
| CPD | Connection Point Descriptor |
| CPE | Customer Premise Equipment |
| CPICH | Common Pilot Channel |
| CQI | Channel Quality Indicator |
| CPU | CSI processing unit, |
| | Central Processing Unit |
| C/R | Command/Response field bit |
| CRAN | Cloud Radio Access Network, |
| | Cloud RAN |
| CRB | Common Resource Block |
| CRC | Cyclic Redundancy Check |
| CRI | Channel-State Information Resource Indicator, |
| | CSI-RS Resource Indicator |
| C-RNTI | Cell RNTI |
| CS | Circuit Switched |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, |
| | Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, |
| | Direct Current |
| DCI | Downlink Control Information |
| DF | Deployment Flavour |
| DL | Downlink |
| DMTF | Distributed Management Task Force |
| DPDK | Data Plane Development Kit |
| DM-RS, DMRS | Demodulation Reference Signal |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. |
| | Digital Subscriber Line |
| DSLAM | DSL Access Multiplexer |
| DwPTS | Downlink Pilot Time Slot |
| E-LAN | Ethernet Local Area Network |
| E2E | End-to-End |
| ECCA | extended clear channel assessment, |
| | extended CCA |
| ECCE | Enhanced Control Channel Element, |
| | Enhanced CCE |
| ED | Energy Detection |
| EDGE | Enhanced Datarates for GSM Evolution (GSM |
| | Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance tableManagement Function |
| EGPRS | Enhanced GPRS |
| EIR | Equipment Identity Register |
| eLAA | enhanced Licensed Assisted Access, |
| | enhanced LAA |
| EM | Element Manager |
| eMBB | Enhanced Mobile Broadband |
| EMS | Element Management System |
| eNB | evolved NodeB, |
| | E-UTRAN Node B |
| EN-DC | E-UTRA-NR Dual Connectivity |
| EPC | Evolved Packet Core |
| EPDCCH | enhanced PDCCH, |
| | enhanced Physical Downlink Control Cannel |
| EPRE | Energy per resource element |
| EPS | Evolved Packet System |
| EREG | enhanced REG, |
| | enhanced resource element groups |
| ETSI | European Telecommunications Standards Institute |
| ETWS | Earthquake and Tsunami Warning System |
| eUICC | embedded UICC, |
| | embedded Universal Integrated Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, |
| | further enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, GSM EDGE Radio Access |
| | Network |
| GGSN | Gateway GPRS Support Node |
| GLONASS | GLObal'naya NAvigatsionnaya Sputnikovaya |
| | Sistema |
| | (Engl.: Global Navigation Satellite System) |
| gNB | Next Generation NodeB |
| gNB-CU | gNB-centralized unit, |
| | Next Generation NodeB centralized unit |
| gNB-DU | gNB-distributed unit, |
| | Next Generation NodeB distributed unit |
| GNSS | Global Navigation Satellite System |
| GPRS | General Packet Radio Service |
| GPSI | Generic Public Subscription Identifier |
| GSM | Global System for Mobile Communications, |
| | Groupe Special Mobile |
| GTP | GPRS Tunneling Protocol |
| GTP-U | GPRS Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure (https is |
| | http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IM | Interference Measurement, |
| | Intermodulation, |
| | IP Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, |
| | Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IR | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN |

Constraint length of the
convolutional code, USIM
Individual key

| | |
|---|---|
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, |
| | Low Layer Compatibility |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec |
| | Tunnel |
| LTE | Long Term Evolution |
| M2M | Machine-to-Machine |
| MAC | Medium Access Control (protocol layering context) |
| MAC | Message authentication code (security/encryption |
| | context) |
| MAC-A | MAC used for authentication and key agreement |
| | (TSG T WG3 context) |
| MAC-I | MAC used for data integrity of signalling |
| | messages (TSG T WG3 context) |
| MANO | Management and Orchestration |
| MBMS | Multimedia Broadcast and Multicast Service |
| MBSFN | Multimedia Broadcast multicast service Single |
| | Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, |
| | Management Information Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, |
| | Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, |
| | MCH Scheduling Information |
| MSID | Mobile Station Identifier |
| MSIN | Mobile Station Identification Number |
| MSISDN | Mobile Subscriber ISDN Number |
| MT | Mobile Terminated, |
| | Mobile Termination |
| MTC | Machine-Type Communications |
| mMTC | massive MTC, |
| | massive Machine-Type Communications |
| MU-MIMO | Multi User MIMO |
| MWUS | MTC wake-up signal, |
| | MTC WUS |
| NACK | Negative Acknowledgement |
| NAI | Network Access Identifier |
| NAS | Non-Access Stratum, |
| | Non-Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, |
| | Next Gen |
| NGEN-DC | NG-RAN E-UTRA-NR Dual Connectivity |
| NM | Network Manager |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, |
| | Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, |
| | Narrowband WUS |
| NZP | Non-Zero Power |
| O&M | Operation and Maintenance |
| ODU2 | Optical channel Data Unit-type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, |
| | Personal Computer |
| PCC | Primary Component Carrier, |
| | Primary CC |
| PCell | Primary Cell |
| PCI | Physical Cell ID, |
| | Physical Cell Identity |
| PCEF | Policy and Charging Enforcement Function |
| PCF | Policy Control Function |
| PCRF | Policy Control and Charging Rules Function |
| PDCP | Packet Data Convergence Protocol, |
| | Packet Data Convergence Protocol layer |
| PDCCH | Physical Downlink Control Channel |
| PDCP | Packet Data Convergence Protocol |
| PDN | Packet Data Network, |
| | Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, |
| | Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, |
| | QoS Flow Identifier |
| QoS | Quality of Service |
| QPSK | Quadrature (Quaternary) Phase Shift Keying |
| QZSS | Quasi-Zenith Satellite System |
| RA-RNTI | Random Access RNTI |
| RAB | Radio Access Bearer, |
| | Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, |
| | Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, |
| | Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, |
| | Remaining Minimum System Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, |
| | Radio Resource Control layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time |
| Rx | Reception, |
| | Receiving, |
| | Receiver |
| S1AP | S1 Application Protocol |
| S1-MME | S1 for the control plane |
| S1-U | S1 for the user plane |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, |
| | Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, |
| | Service Data Adaptation Protocol layer |
| SDL | Supplementary Downlink |
| SDNF | Structured Data Storage Network Function |
| SDP | Session Description Protocol |
| SDSF | Structured Data Storage Function |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, |
| | SFN and frame timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, |
| | Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH | Block |
| SSBRI | SS/PBCH Block Resource Indicator, |
| | Synchronization Signal Block Resource Indicator |
| SSC | Session and Service Continuity |
| SS-RSRP | Synchronization Signal based Reference Signal |
| | Received Power |
| SS-RSRQ | Synchronization Signal based Reference Signal |
| | Received Quality |
| SS-SINR | Synchronization Signal based Signal to Noise and |
| | Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, |
| | Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, |
| | Technical Standard |
| TTI | Transmission Time Interval |
| Tx | Transmission, |
| | Transmitting, |
| | Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, |
| VLAN | Virtual LAN, |
| | Virtual Local Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, |
| | Voice-over-Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Po |

1-20. (canceled)

21. An apparatus of a user equipment (UE) in a wireless communication system for determining a transmission configuration for reception of a physical downlink shared channel (PDSCH), the apparatus comprising:
transceiver configured to receive downlink control information (DCI) in a DCI format (1_1 or 1_2); and
a processor operatively coupled to the transceiver and configured to:
identify a transmission configuration indicator (TCI) state codepoint indicated by the DCI;
determine, based on a number of TCI states mapped to the TCI state codepoint and a value of an indicator field, whether to apply a first TCI state, a second TCI state, or both TCI states to a scheduled physical downlink shared channel (PDSCH); and
operate, based on the determination, in one of a single transmit-receive point (sTRP) mode or a multi-TRP (mTRP) mode to receive the scheduled PDSCH.

22. The apparatus of claim 21, wherein the indicator field comprises two bits, each bit pattern corresponding to a mode of operation, the bit pattern ‘00’ indicating application of the first TCI state, ‘01’ indicating application of the second TCI state, and ‘10’ or ‘11’ indicating application of both TCI states.

23. The apparatus of claim 21, wherein when the number of TCI states mapped to the TCI state codepoint is one, the UE assumes sTRP operation irrespective of the value of the indicator field.

24. The apparatus of claim 21, wherein when the number of TCI states mapped to the TCI state codepoint is two or more, and the indicator field indicates application of both TCI states, the UE assumes mTRP operation based at least on one of: frequency-division multiplexing scheme A (FDM Scheme-A), frequency-division multiplexing scheme B (FDM Scheme-B), or time-division multiplexing scheme A (TDM Scheme-A).

25. The apparatus of claim 21, wherein if a time division resource allocation (TDRA) DCI field indicates a repetition number in PDSCH time domain resource allocation, and the indicator field indicates application of both TCI states, the UE performs mTRP operation according to time-division multiplexing scheme B (TDM Scheme-B) with inter-slot repetition.

26. The apparatus of claim 21, wherein each TCI state mapped to the TCI codepoint corresponds to a different transmission and reception point (TRP), and a TCI to TRP mapping is based on an identifier (ID) configured via medium access control (MAC) control element (CE).

27. The apparatus of claim 21, wherein the processor is further configured to apply the TCI state(s) indicated by the DCI starting from a first slot that is at least a predetermined number of symbols, defined as a beam application time (BAT), after a last symbol of a physical uplink control channel (PUCCH) or physical uplink shared channel (PUSCH).

28. The apparatus of claim 21, wherein upon receiving a TCI codepoint mapped to one of TCI-States, the UE updates the TCI state indicated by the DCI and maintains a previously activated TCI state not indicated in the DCI.

29. The apparatus of claim 21, wherein if the scheduling offset between the DCI and the PDSCH is below a predefined threshold, and the UE does not support two default beams in frequency range 2 (FR2), the PDSCH is scheduled in sTRP mode.

30. A non-transitory computer-readable medium storing instructions that, when executed by one or more processors of a user equipment (UE) in a wireless communication system, cause the UE to:
receive downlink control information (DCI) in a DCI format 1_1 or 1_2;
identify a transmission configuration indicator (TCI) state codepoint indicated by the DCI;
determine, based on a number of TCI states mapped to the TCI state codepoint and a value of an indicator field, whether to apply a first TCI state, a second TCI state, or both TCI states to a scheduled physical downlink shared channel (PDSCH); and
receive one or more PDSCH transmission occasions across one or more slots, wherein a number of the PDSCH transmission occasions is based on the number of TCI states indicated by the DCI.

31. The non-transitory computer-readable medium of claim 30, wherein the indicator field comprises two bits, each bit pattern corresponding to a mode of operation, the bit pattern ‘00’ indicating application of the first TCI state, ‘01’ indicating application of the second TCI state, and ‘10’ or ‘11’ indicating application of both TCI states.

32. The non-transitory computer-readable medium of claim 30, wherein when the number of TCI states mapped to the TCI state codepoint is one, the scheduled physical downlink shared channel (PDSCH) is received using a single TCI state, irrespective of the value of the indicator field.

33. The non-transitory computer-readable medium of claim 30, wherein when the number of TCI states mapped to the TCI state codepoint is two or more, and the indicator field indicates application of both TCI states, the scheduled PDSCH is received in multiple transmission occasions based at least on one of: frequency-division multiplexing scheme A, frequency-division multiplexing scheme B, or time-division multiplexing scheme A.

34. The non-transitory computer-readable medium of claim 30, wherein when a time domain resource allocation field in the DCI indicates a repetition number and the indicator field indicates application of both TCI states, the scheduled PDSCH is received in repeated transmissions across multiple slots according to time-division multiplexing scheme B with inter-slot repetition.

35. The non-transitory computer-readable medium of claim 30, wherein each TCI state mapped to the TCI state codepoint corresponds to a different transmission and reception point, and a mapping between the TCI state and the transmission and reception point is based on an identifier configured via a medium access control (MAC) control element (CE).

36. The non-transitory computer-readable medium of claim 30, wherein the instructions further cause the UE to apply the TCI state or states indicated by the DCI starting from a first slot that is at least a predetermined number of symbols, defined as a beam application time (BAT), after a last symbol of a physical uplink control channel (PUCCH) or physical uplink shared channel (PUSCH).

37. The non-transitory computer-readable medium of claim 30, wherein upon receiving a TCI state codepoint mapped to one or more TCI states, the instructions further cause the UE to update the TCI state indicated by the DCI and maintain any previously activated TCI state that is not indicated by the DCI.

38. A method of determining a transmission configuration for reception of a physical downlink shared channel (PDSCH) by a user equipment (UE) in a wireless communication system, the method comprising:
receiving, via a transceiver, downlink control information (DCI) in a DCI format 1_1 or 1_2;
identifying, by a processor, a transmission configuration indicator (TCI) state codepoint indicated by the DCI;
determining, based on a number of TCI states mapped to the TCI state codepoint and a value of an indicator field, whether to apply a first TCI state, a second TCI state, or both TCI states to a scheduled PDSCH; and
operating, based on the determination, in one of a single transmit-receive point (sTRP) mode or a multi-transmit-receive point (mTRP) mode to receive the scheduled PDSCH.

39. The method of claim 38, wherein the indicator field comprises two bits, each bit pattern corresponding to a mode of operation, the bit pattern ‘00’ indicating application of the first TCI state, ‘01’ indicating application of the second TCI state, and ‘10’ or ‘11’ indicating application of both TCI states.

40. The method of claim 38, wherein when the number of TCI states mapped to the TCI state codepoint is one, the UE operates in the single transmit-receive point (sTRP) mode irrespective of the value of the indicator field.
